(19) United States
(12) Patent Application Publication
(10) Pub. No.: US 2004/0167706 A1
(43) Pub. Date: Aug. 26, 2004

(54) Web based system providing GPS waypoint information

(76) Inventor: Daniel C. Becker, Denville, NJ (US)

Correspondence Address: HARNESS, DICKEY & PIERCE, P.L.C., P.O. Box 8910, Reston, VA, 20195, US

(21) Appl. No.: 10/372,117

(22) Filed: Feb. 25, 2003

(51) Int. Cl. G01C 21/00

(52) U.S. Cl. 701/206; 701/213; 342/357.06

(57) ABSTRACT

A web-based system includes an interface and a searchable database providing waypoint information for use by a GPS device. The waypoint information is formatted for the GPS device and search fields allow for defining a search of the database for particular waypoint information.

### FIELD OF THE INVENTION

The present invention relates generally to global positioning system (GPS) devices.

### BACKGROUND OF THE INVENTION

GPS uses a network of satellites that allow for determining the location of a specific GPS device by measuring the distance of the GPS device from the satellites. More particularly, the GPS device determines its location based upon the location of specific GPS satellites and its distance from those satellites.

In general, a GPS device allows for recording or creating of geographic location points within the device and provides for navigating between these geographic location points using the satellites. Different types of GPS devices are known that provide various features, including for example, maps having a view of the surrounding geographic area. These maps typically show interstates, highways, major thoroughfares, lakes, rivers, railroads, etc. These GPS devices also provide for creating or downloading waypoint data to identify specific areas (e.g., parks or camp grounds) of interest. GPS devices with no map detail typically provide a view of the current location relative to any waypoints, and may show a particular route or trip that has been created. The GPS screen allows for determining the position of the GPS device relative to these waypoints. Typically, when downloading waypoint or detailed map data, such information is downloaded from a CD ROM to a computer for transfer to a GPS device, and may include, for example, address information relating to these waypoints (e.g., tourist attractions). Downloading of the waypoint information to the GPS device is provided using, for example, a serial connection between the computer and the GPS device or a data storage cartridge.

With respect generally to waypoints, these are locations or landmarks recorded and stored in the GPS device. For example, these waypoints may be check points on a route or significant ground features. Waypoints may be defined and stored in the GPS device manually by taking coordinates of the waypoint from a map or other reference. More typically, waypoints are entered directly by taking a reading with the unit at the location itself, giving it a name and then saving the point. Waypoints also may be created by referencing other waypoints already stored and entering the distance and compass bearing to the new waypoint. Additionally, waypoint information may be downloaded to the GPS device.

Waypoints allow for navigation between different geographic points using the GPS device. These waypoints also allow for plotting routes or trips. However, in order to obtain the waypoint information, the tedious process of entering the geographic location or calculating distances from other locations is required. Alternately, a CD ROM must be used with the waypoint information downloaded to computer before it can be accessed and thereafter downloaded from the computer to the GPS device. Further, access is limited to the information contained on the CD ROM, which is typically only updated on a periodic basis and requires use of yet another CD ROM.

### SUMMARY OF THE INVENTION

In the present invention a web-based system provides waypoint information for use by a GPS device. The web-based system includes a database containing waypoint information and GPS formatting information, and a web-based interface for accessing the waypoint information. The accessed web-based waypoint information is configured for use with a particular GPS device using the GPS formatting information. Specifically, the waypoint information contained in the database is converted to a particular GPS format for use in the GPS device and may be accessed directly by the GPS device. The web-based interface provides selectable fields for searching the waypoint information in the database and downloading of the selected waypoint information to a GPS device.

In one embodiment, the web-based interface is configured to provide the accessed waypoint information to the GPS device in a particular GPS format. The web-based interface may include selectable fields for searching the waypoint information in the database.

In another embodiment, a device for accessing waypoint information includes a user input interface for inputting search criteria for use in connection with a web-based interface to access a web-based database containing waypoint information; a processor configured to request waypoint information from the web-based database based upon the search criteria and download the requested waypoint information using the web-based interface; a display for displaying the downloaded waypoint information; and a GPS component using the downloaded waypoint information to provide directional information (i.e., location and navigation information). The GPS component may be operatively connected to a device (e.g., Personal Digital Assistant (PDA)) having the user input interface, processor and display, with the device configured for wireless web-based access. Further, the search criteria may be configured to provide selection from business name, business type, GPS device manufacturer, GPS device model, city, state and distance.

### BRIEF DESCRIPTION OF THE DRAWINGS

The present invention will become more fully understood from the detailed description and the accompanying drawings, wherein:

FIG. 1 is a simplified block diagram of a GPS system with a GPS device;

FIG. 2 is a plan view of an exemplary GPS device in connection with which the present invention may be implemented;

FIG. 3 is a plan view of an exemplary PDA device having a GPS module in connection with which the present invention may be implemented;

FIG. 4 is a block diagram of a web-based system of one embodiment of the present invention for providing waypoint information to a GPS device;

FIGS. 5(a) and 5(b) are block diagrams illustrating downloading waypoint information from a web-based system of various embodiments of the present invention to a GPS device;

FIG. 5(c) is a block diagram illustrating downloading waypoint information from a web-based system of various embodiments of the present invention to a cellular device;

FIGS. 6(a) and 6(a) are search menus of various embodiments of the present invention for defining a search for waypoint information;

FIG. 7 is a results display of various embodiments of the present invention;

FIG. 8 is a flow chart of one embodiment of the present invention for formatting waypoint information for use by a GPS device; and

FIG. 9 is a flow chart showing the operation of the web-based system of various embodiments of the present invention.

### DETAILED DESCRIPTION OF THE PREFERRED EMBODIMENTS

The following description of the preferred embodiments is merely exemplary in nature and is in no way intended to limit the invention, its application, or uses. Although the present invention is described in connection with GPS devices having specific component parts and providing a set of features/options, it is not so limited and different or additional component parts and features/options may be implemented as part of the invention.

A general description of a GPS device in connection with which the present invention may be implemented will first be provided. A detailed structural description of the invention and its operation will follow.

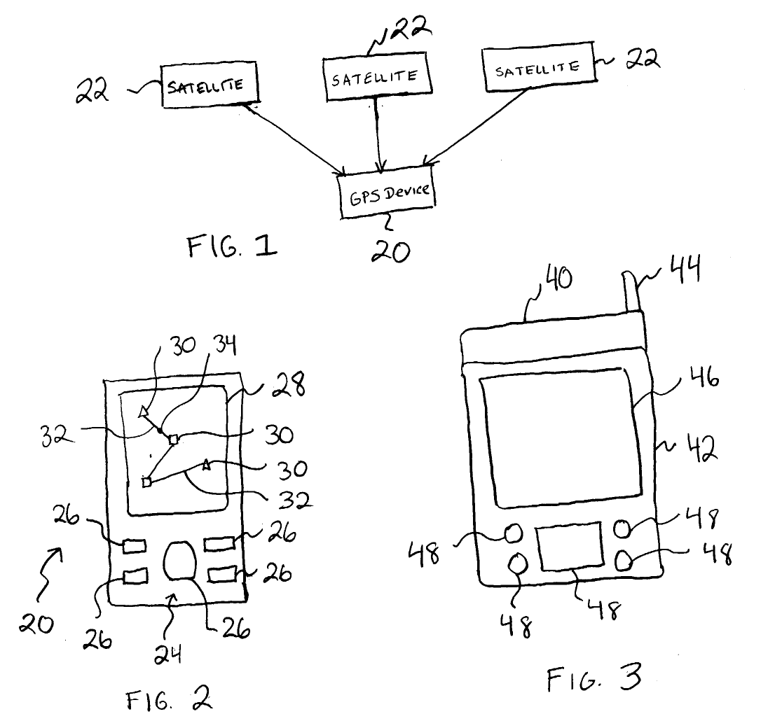

As shown generally in FIG. 1, a GPS device 20 typically receives signals from a plurality of satellites 22 to determine and provide location information. Each satellite 22 transmits low power radio signals on several frequencies with the GPS device 20 configured to receive these radio signals. The satellites 22 transmit location information identifying the approximate location of the satellite 22 and the GPS device 20 uses the location information along with the delay time in the signals to calculate the travel time from the satellite 22 to the GPS device 20. Thereafter, using waypoint information stored within the GPS device 20, location and navigation information is ascertainable.

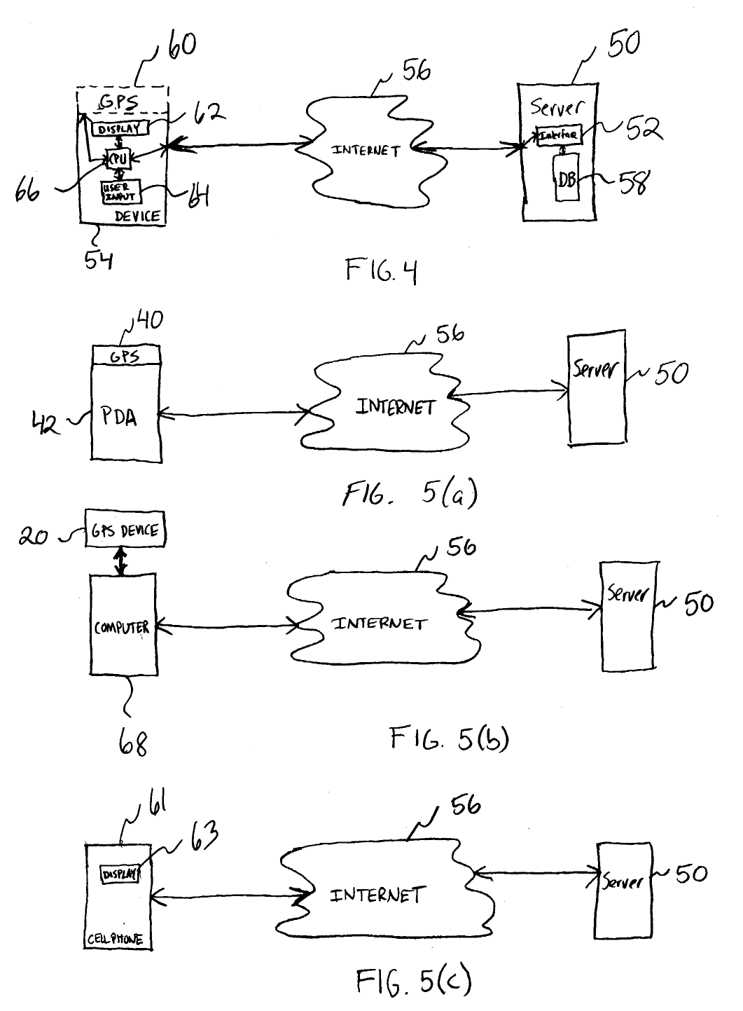

An exemplary GPS device 20 as shown in FIG. 2 includes a user input interface 24 having user input members 26 (e.g., depressible buttons) for operating and programming the GPS device 20, a display 28 for displaying location and navigation information and a processor (not shown) for processing the received signal information from the satellites 22 to provide the location and navigation information. Typically, waypoint icons 30 are displayed to identify particular programmed location points, which may be part of, for example, a selected travel route 32. A separate location identifier 34 is provided to identify the geographic location of the GPS device 20 relative to the waypoint icons 30. The waypoint icons 30 may be configured in recognizable shapes (e.g., airplane for airport) to easily identify the particular waypoint or a map of the particular geographic area including major roads and landmarks may be provided. Using the waypoint icons 30 and plotted travel route 32, navigation is thereby provided using the GPS device 20. It should be noted that other features and functionality may be provided in connection with the GPS device 20. For example, timers, alarms, travel speed, etc. may be provided in connection with the GPS device 20.

The GPS device 20 may be a stand alone unit or may be provided as part of another device. For example, and as shown in FIG. 3, a GPS module 40 may be configured for removable connection to a PDA 42 to provide GPS functionality as described herein. The PDA 42 further may be configured for remote access to the Internet and also includes a display 46, user input members 48 and a processor (not shown). An antenna 44 may be provided to transmit and receive signals to provide remote Internet communication.

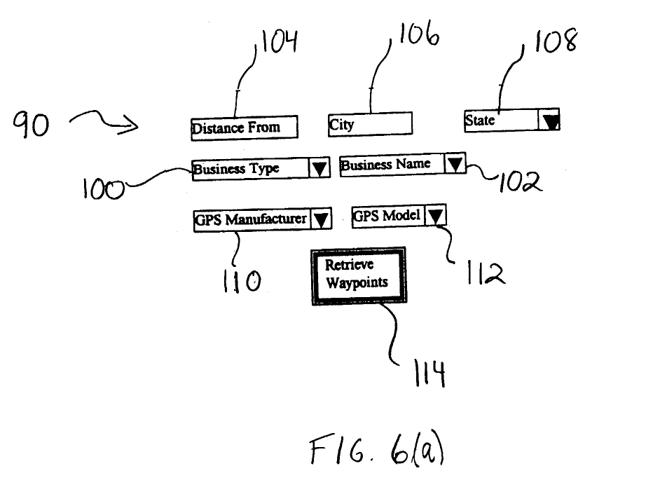

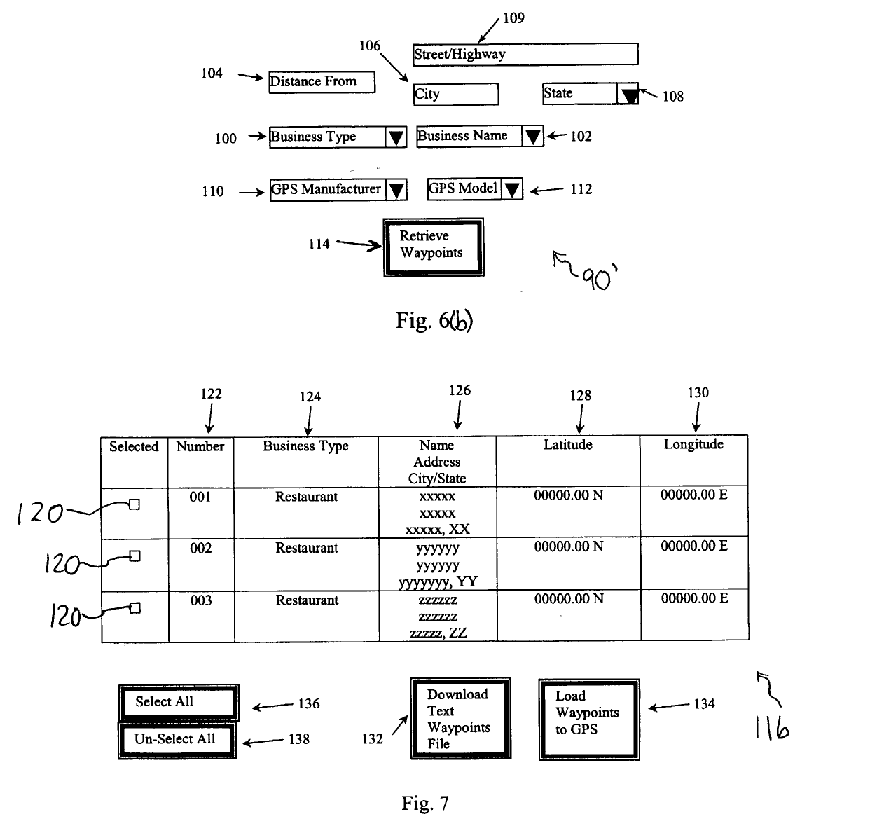

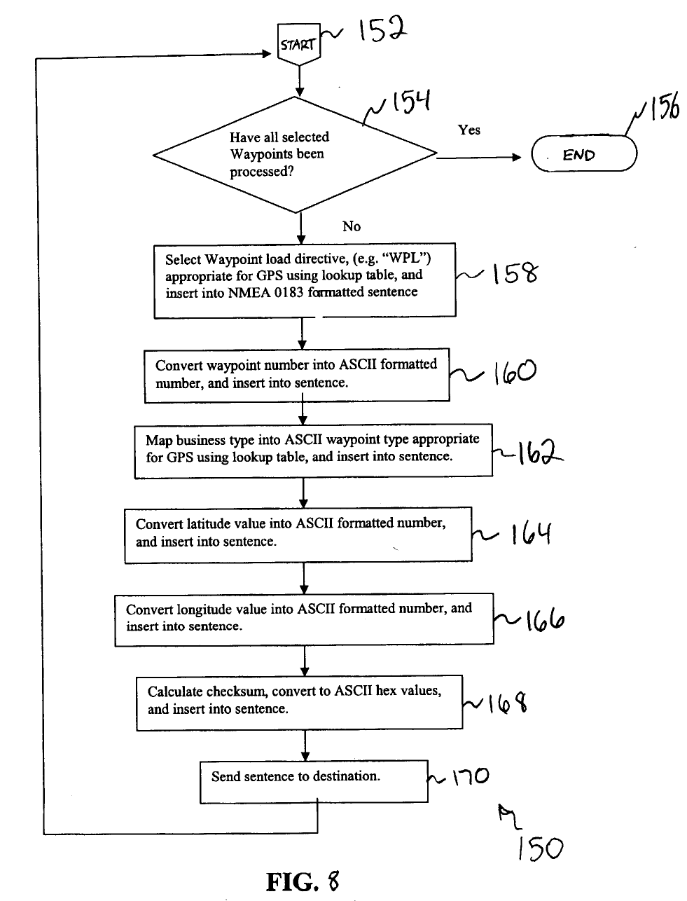

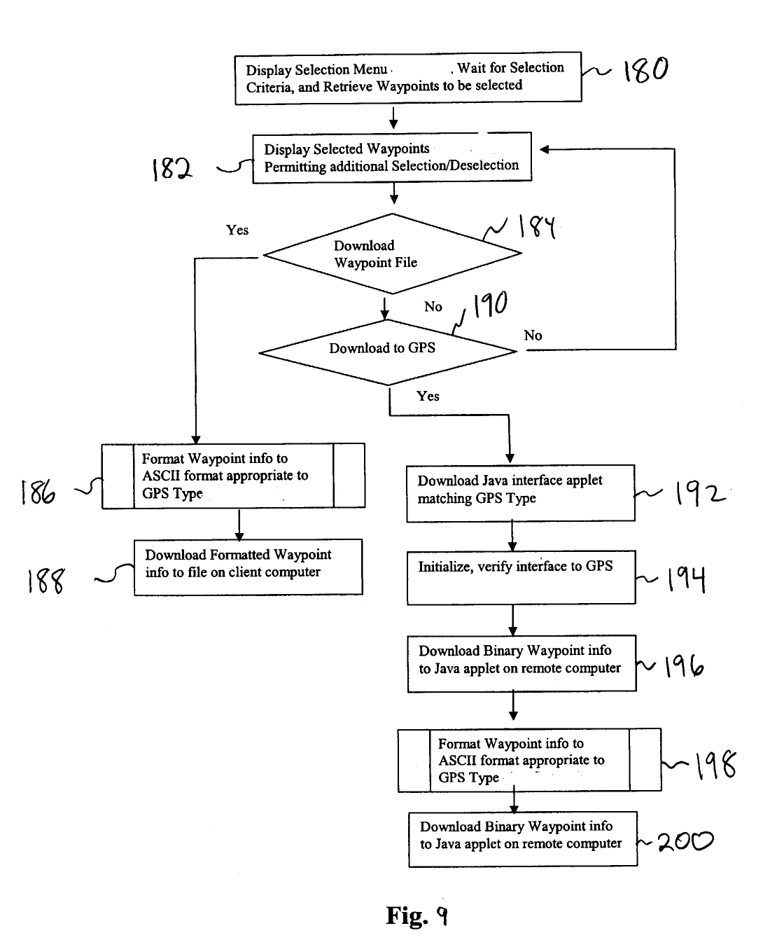

Having generally illustrated and discussed exemplary GPS devices, various embodiments of the present invention will now be described. As shown in FIG. 4, a web-based system 50 shown in exemplary form as a server includes a web-based interface 52 for communicating waypoint information to a device 54 via the Internet 56. In particular, the web-based interface 52 is connected to a database 58 (i.e., web-based database) to access waypoint information and GPS formatting information contained therein and as described in more detail herein. The accessed waypoint information from the database 58 is formatted and communicated to the device 54 and used for GPS navigation by a GPS component 60. As described herein, the GPS component 60 may be a stand alone GPS device 20 or may be provided as a separate module 40. A display 62, user input member 64 and processor 66 (e.g., CPU) are provided in connection with the GPS component 60 in its various different forms.

The web-based database 58 includes the waypoint information, which information is preferably stored such that a separate record number is associated with each different waypoint. Further, each record includes specific information regarding that waypoint, including, for example, geographic location (i.e., longitude and latitude), identifying information (i.e., business name, business type, city and state) and type of icon (e.g., airplane) to use on the display 28. The web-based database 58 also includes the GPS formatting information for use in communicating with different devices 54 (e.g., different GPS devices). In one embodiment, the GPS formatting information is configured as a lookup table having specific formatting information for different types of devices 54. In particular, the look-up table includes commands for use in controlling and communicating with different types of devices 54, such as different directive names (i.e., commands) for use with different devices 54. The look-up table also includes information regarding the type of interface to use to communicate with different devices 54 and the format in which the data must be communicated to the different devices. This format information may include, for example, whether information is to be communicated in a particular form (e.g., numerical data in binary or decimal form), the order of the data (e.g., longitude information before latitude information), and the particular format of the commands (e.g., the particular directive name or command to use to communicate data and load into the memory of a particular GPS device). It should be noted that the waypoint information and GPS formatting information may be provided in separate databases or separate physical storage units depending upon the particular system requirements, and is not limited to storage in a single database (i.e., the web-based database 58).

With respect to accessing the waypoint information, and as shown in FIGS. 5(a) and 5(b), when configured as a stand alone unit, the GPS device 20 communicates with a computer 68, for example via a serial PC interface cable, to access waypoint information stored therein that was received via the Internet 56 and accessed using the web-based interface 52. When configured as a module 40, the waypoint information may be obtained directly from the Internet 56 via the PDA 42 (e.g., by wireless Internet access) and accessed using the web-based interface 52. As shown in FIG. 5(c), when configured as a cellular device, such as a wireless web-enabled cellular telephone 61 having a display 63, the waypoint information may be obtained directly from the Internet 56 for display on the display 63.

With respect to accessing the waypoint information, in one embodiment shown in FIG. 6(a), the web-based interface 52 provides a search menu 90 having search fields for searching the web-based database 58. The search menu 90 is preferably configured as a web-page allowing user input of search criteria for specific waypoint information.

In particular, a plurality of search fields are displayed, for example, on the display 46, to define the search criteria. In one embodiment, the following search fields are each separately provided and selectable by a user: Business Type field 100, Business Name field 102, Distance From field 104, City field 106, State field 108, GPS Manufacturer field 110 and GPS Model field 112. These search fields may be configured as pull-down menus having a predetermined list of selectable search criteria and/or as user input fields. For example, in one embodiment, the Business Type field 100, Business Name field 102, GPS Manufacturer field 110 and GPS Model field 112 are pull down menus. It should be noted that the search fields may be required or optional.

Further, the search fields may be configured to provide specific search criteria. For example, in one embodiment, the Business Type field 100 includes restaurants, hotels, gas stations, department stores, grocery stores, automobile repair facilities and pharmacies. However, this list is merely exemplary and may be modified as needed. Further, the Business Name field 102 is configured accordingly to include businesses for each of the predetermined business types in the pull down menu. Also, an “all” selection is provided for accessing all business names and types within the web-based database 48. Additionally, the GPS Model field 112 includes a list of the GPS models for a particular GPS manufacturer selected in the GPS Manufacturer field 110.

Using the search fields, a waypoint search is defined. In particular, and for example, a user inputs a center location using the City and State fields 106, a distance from the center location using the Distance From field 104, a business type and/or business name of interest using the Business Type and Business Name fields 100 and 102, and a GPS manufacturer and model using the GPS Manufacturer and GPS Model fields 110 and 112 to define a search. It should be noted that the search fields are not limited to those described herein, but may be modified to provide additional or different searching functionality. For example, as shown in FIG. 6(b), in another embodiment, the web-based interface 52 provides a search menu 90′ having an additional Street/Highway field 109 for selecting a particular travel route along a specified highway. As another example, the selection of a zip code may be provided to define the search.

Further, different search options may be provided, including for example, using wildcard searches wherein only part of a business name is provided (e.g., Mar*). Additionally, the search menu 90 may include fixed search fields, for example, Business Type and Name 100 and 102 when accessing the search menu 90 using a link to a particular web-site for a specific business. Such a web-page having the search menu 90 would include company identifying information (e.g., company name and logo) with some of the search fields fixed.

Once a particular waypoint search is defined using the search fields, a search of the web-based database 58 using the web-based interface 52 is initiated, for example, by selecting a Retrieve Waypoints selection member 114 (e.g., Retrieve Waypoint icon). Thereafter, and in one embodiment, waypoint information matching the specific search criteria is provided via the Internet 56 and displayed to a user on a results display 116 (e.g., a results web-page) as shown in FIG. 7. It should be noted that the results display 116 may be provided separate from the search menu 90 (e.g., as a different screen or web-page) or may be provided together (e.g., on the same screen or web-page). The results display 116 allows the user to review the search results, which may be formatted, for example, as a list of waypoints, and provides further selection criteria. In particular, the displayed waypoints are each associated with a selection member 120 (e.g., selection check-box), which may be selected, not selected, or de-selected if previously selected by a user (e.g., clicking on the check-box with a virtual arrow using a computer mouse). The results display 116 also provides for selection or deselection of all displayed waypoints by a user (e.g., using a computer mouse) using a Select All selection member 136 and an Un-Select All selection member 138, respectively (e.g., Select All and Un-Select All icons).

It should be noted that when using a cellular device, such as a wireless web-enabled cellular telephone 61 as shown in FIG. 5(c), or other device that does not have the capability to be connected directly to a GPS device 20, or where a GPS device 20 is not immediately available, a user has the option of directly viewing the displayed waypoint information (e.g., on the display 63 of the wireless web-enabled cellular telephone 61). In such a case, the displayed waypoint information is used for manual navigation by the user. For example, a user may use their present known address or location to provide their own means of navigation to the desired waypoint (e.g., based upon the user's knowledge of the streets in the area). In this embodiment, the GPS Manufacturer field 110 and GPS Model field 112 include a “none” selection that enables a customized display for manual use (e.g., display providing detailed information, such as the addresses, for the waypoints resulting from the search). Further, and for example, the web-based interface 52 may be configured to allow for input of a known address and location by a user receiving the waypoint information on a wireless web-enabled cellular telephone 61, and thereafter provide directions to a particular waypoint based upon the input information using known techniques for providing directions, for example, between two addresses (e.g., directions from the user input location to the closest restaurant of interest identified by a waypoint resulting from a search).

Referring again to FIG. 7, the results display 116 includes columns providing specific information regarding each of the waypoints resulting from the waypoint search. For example, and in one embodiment, a number column 122 separately identifies each waypoint by number (i.e., waypoint number), a Business Type column 124 provides information regarding the type of business associated with that waypoint (e.g., a restaurant) and a Name, Address, City/State column 126 provides the name and location information (e.g., address, city/state) associated with each of the waypoints. Further, geographic location information (e.g., latitude and longitude information) associated with each of the waypoints is provided in a Latitude column 128 and Longitude column 130.

A Download Text Waypoints File selection member 132 is provided and may be selected by a user. Selection of the Download Text Waypoints File selection member 132 results in the waypoint information (e.g., business type, name, address, city/state, latitude, longitude, etc.) being provided (e.g., downloaded) in text form formatted for a selected GPS manufacturer (e.g., as selected using the GPS Manufacturer field 110 and GPS Model field 112). A Load Waypoints to GPS selection member 134 is also provided and may be selected by a user. Selection of the Load Waypoints to GPS selection member 134 results in the waypoint information being downloaded directly to a GPS unit, for example, connected to a computer. The waypoint information is formatted for the particular GPS unit selected using the GPS Manufacturer field 110 and GPS Model field 112.

In particular, a properly formatted waypoint file for the GPS manufacturer and model selected is provided and includes all the waypoint information satisfying the particular search criteria. Essentially, this waypoint information is provided in a GPS format for use by the particular GPS device 20. In one embodiment, a popup window is displayed allowing for selection of a particular location (e.g., directory on a computer 68 or in a PDA 42) for downloading of the waypoint file. If the waypoint file is downloaded to a computer 68 it may then be downloaded to a GPS device 20. If a web-enabled GPS device 20 (e.g., PDA 42 with GPS module 40) is used, accessing the search menu 90 is provided directly from the PDA 42, with the waypoint file downloaded directly and remotely to the PDA 42. Thus, a waypoint file is generated on the web-based system 50 (e.g., server) that contains waypoint information satisfying the search criteria and converted to a particular GPS format for the specified GPS device 20.

In one embodiment, a program, such as, for example, a java type script is provided for use in performing the waypoint search of the web-based database 58 using the web-based interface 52 and for formatting the waypoint information. The script is executed, for example, as a client on a computer 68 or a PDA 42 with the waypoint file downloaded to the client side using the script. Upon defining a search using the search fields, a search of the web-based database 58 is performed using the web-based interface 52 controlled by the script.

The results of the search (i.e., waypoint data) are thereafter formatted to a particular GPS device 20 manufacturer and model. Specifically, the waypoint file is formatted to a particular GPS protocol for a specific GPS device 20 as described in more detail herein and shown in FIGS. 8 and 9. In particular, using the known format of the waypoint information in the web-based database 58 and the required format for the particular GPS device 20, the waypoint information is appropriately formatted. For example, a conversion from a binary number format to an ASCII number may be required.

Specifically, one exemplary procedure 150 for formatting the waypoint information is shown in FIG. 8. The procedure 150 is initiated at 152, for example by a user selecting the Load Waypoints to GPS selection member 134. A determination is made at 154 as to whether all selected waypoints that were selected by a user, for example, using the selection member 120, have been processed (e.g., formatted for downloading). If all selected waypoints have been processed then the procedure terminates at 156. If all the selected waypoints have not been processed as determined at 154, then at 158 a waypoint load directive (e.g., waypoint location (WPL) load command) for a particular GPS device is selected using the GPS formatting information provided in one embodiment in a lookup table as part of the web-based database 58. The waypoint load directive is inserted into an NMEA 0183 formatted sentence for use by the particular device (i.e., encoding the waypoint information for use by a particular GPS device).

The waypoint information is thereafter formatted in sentence form using ASCII text for use by the particular GPS device (e.g. for downloading and access by a GPS device). In particular, at 160 the waypoint number is converted into an ASCII formatted number and inserted into the sentence. At 162, the business type information is mapped into an ASCII waypoint type for a particular GPS device using the lookup table, and then inserted in the sentence. The latitude value for the waypoint is converted into an ASCII formatted number at 164 and inserted into the sentence. The longitude value is converted into an ASCII formatted number at 166 and inserted into the sentence. A checksum value is calculated and converted to an ASCII hex value at 168 and inserted into the sentence for use in validating the data. It should be appreciated by one skilled in the art that different types of checksum methods may be implemented to provide data validation and to determine whether any data was, for example, corrupted during transmission. The formatted sentence is then sent to its destination (e.g., downloaded to a GPS device) at 170. Thereafter, a determination is again made at 154 as to whether all the selected waypoints have been processed. It should be noted that the particular order in which the waypoint information is configured and provided to a particular GPS device 20 may have to be modified. For example, the GPS device 20 may require longitude and latitude information before other information as determined by the GPS formatting information in the lookup table. Thus, the procedure 150 may be modified accordingly.

In operation, the web-based system 50 including the web-based interface 52 allows for communicating to a device 54 waypoint information formatted for that particular device 54. Specifically, and as shown in FIG. 9, a search menu 90, 90′ as shown in FIGS. 6(a) and 6(b) is provided that includes search fields that allows for a user defined search for waypoint information at 180. The waypoint information is retrieved from the database 58. At 182, waypoint information satisfying the user defined search is then displayed on the results display 116 as shown in FIG. 7. The results display allows for selection/deselection of specific waypoints and associated information for downloading. A determination is made at 184 as to whether the Download Text Waypoints File selection member 132 has been selected. If it has been selected, then at 186, the selected waypoint information (i.e., selected by a user for downloading using the results display 116) is formatted for a particular GPS unit type (e.g., GPS Manufacturer and GPS Model) using the procedure 150 shown in FIG. 8. Thereafter, the formatted waypoint information is downloaded to, for example, a file on a client computer at 188.

If a determination is made at 184 that the Download Text Waypoints File selection member 132 has not been selected, then at 190 a determination is made as to whether the Load Waypoints to GPS selection member 134 has been selected. If not, then the waypoint information satisfying the user defined search is again displayed at 182. If the Load Waypoints to GPS selection member 134 has been selected, then at 192 a Java interface applet matching the GPS unit type is downloaded, for example, to the client web-browser running on a remote computer. Thereafter, verification of a proper interface from, for example, the remote computer to a GPS device (e.g., confirm communication with a connected GPS device to ensure that the device is of the type specified or to confirm that a GPS is connected) is provided in any known manner at 194. Binary waypoint information from the database 58 is then downloaded to the Java applet on the remote computer at 196. Then at 198, the selected waypoint information (i.e., selected by a user for downloading using the results display 116) is formatted for a particular GPS unit type (e.g., GPS Manufacturer and GPS Model) using the procedure 150 shown in FIG. 8. Thereafter, at 200, the formatted waypoint information is downloaded to the Java applet on the remote computer, and then communicated (e.g., downloaded) to the GPS device.

Thus, the present invention provides a web-based system for defining a search for waypoint information, downloading the desired waypoint information and formatting the downloaded waypoint information for use directly by the GPS device 20. By selecting a particular manufacturer and model, a properly formatted waypoint file is provided for use by a particular GPS device 20.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A web-based system providing waypoint information for use by a GPS device comprising:
a database containing waypoint information and GPS formatting information; and
a web-based interface for accessing the waypoint information and GPS formatting information, and configured to provide the waypoint information to a GPS device.

2. The web-based system according to claim 1, wherein the web-based interface is further configured to convert the waypoint information to a GPS format.

3. The web-based system according to claim 2, further comprising a web-based script for converting the waypoint information.

4. The web-based system according to claim 1, wherein the waypoint information comprises business location information.

5. The web-based system according to claim 1, wherein the web-based interface comprises selectable fields for searching the waypoint information in the database.

6. The web-based system according to claim 5, wherein the selectable fields are configured to provide search criteria selected from business name, business type, GPS device manufacturer, GPS device model, street, city, state and distance.

7. The web-based system according to claim 1, wherein the web-based interface is configured to allow for downloading of selected waypoint information from a computer to the GPS device.

8. The web-based system according to claim 1, wherein the web-based interface is configured to allow for downloading of selected waypoint information to the GPS device.

9. The web-based system according to claim 1, wherein the web-based interface is configured to allow for downloading of selected waypoint information to a web-enabled cellular device.

10. The web-based system according to claim 1, wherein the database comprises record numbers with each record number corresponding to information relating to one waypoint.

11. The web-based system according to claim 1 wherein the GPS formatting information is configured as a lookup table having information therein relating to one or more GPS devices.

12. The web-based system according to claim 2 wherein the web-based interface is further configured to provide communication of the formatted waypoint information using an NMEA 0183 formatted command.

13. The web-based system according to claim 12 wherein the web-based interface is further configured to convert binary waypoint information to ASCII formatted information.

14. The web-based system according to claim 1 wherein the web-based interface is further configured to provide the waypoint information in one of (i) a text form formatted for a user selected GPS device and (ii) GPS format for direct downloading to the user selected GPS device.

15. A device for accessing waypoint information comprising:
a user input interface for inputting search criteria for use in connection with a web-based interface to access a web-based database containing waypoint information;
a processor configured to request waypoint information from the web-based database based upon the search criteria and download the requested waypoint information using the web-based interface;
a display for displaying the downloaded waypoint information; and
a GPS component using the downloaded waypoint information to provide directional information.

16. The device according to claim 15, wherein the GPS component is operatively connected to a PDA device having the user input interface, processor and display, and configured for wireless web-based access.

17. The device according to claim 15, wherein the waypoint information comprises business location information.

18. The device according to claim 15, wherein the search criteria is configured to provide selection from business name, business type, GPS device manufacturer, GPS device model, city, state and distance.

19. The device according to claim 18, wherein the display is configured to display identifying indicia relating to a business and wherein at least one of the search criteria relating to the business is fixed.

20. The device according to claim 15, wherein at least one of the search criteria is provided using a pull-down menu.

21. The device according to claim 15, wherein at least one of the search criteria is provided having a user input portion for entry of search criteria by a user.

22. A method of providing web-based waypoint information for use by a GPS device comprising:
accessing the web-based waypoint information; and
formatting the accessed web-based information for use by the GPS device.

23. The method according to claim 22, wherein the step of accessing comprises searching a database containing the waypoint information.

24. The method according to claim 23, wherein the step of searching comprises using search criteria to define a search.

25. The method according to claim 22, wherein the step of accessing comprises transferring the waypoint information to the GPS device.

26. A method of providing waypoint information for use by a GPS device comprising:
receiving a user input for waypoint information;
requesting the waypoint information from a web-based database based upon the user input; and
receiving the waypoint information, which is in a GPS format for use by the GPS device.

27. The method according to claim 26 wherein the requesting step requests the waypoint information using search constraints defining a search for the waypoint information.

28. The method according to claim 27 further comprising displaying the selected search constraints and search results.
